(19) United States
(12) Patent Application Publication
(10) Pub. No.: US 2018/0203892 A1
(43) Pub. Date: Jul. 19, 2018

(54) INJECTION OF TUPLES INTO STREAMS

(71) Applicant: International Business Machines Corporation, Armonk, NY (US)

(72) Inventors: Alexander Cook, Rochester, MN (US); Jason A. Nikolai, Rochester, MN (US); John M. Santosuosso, Rochester, MN (US)

(21) Appl. No.: 15/407,900

(22) Filed: Jan. 17, 2017

(51) Int. Cl. G06F 17/30

(52) U.S. Cl. CPC G06F 17/30371; G06F 17/30554; G06F 17/30466; G06F 17/30516

(57) ABSTRACT

A method, a computing system and a computer program product are provided for controlling processing of streaming data within a distributed computing environment. During the processing of the streaming data, one or more conditions may be detected within the distributed computing environment. In response to detecting the one or more conditions, one or more data sets may be injected into the streaming data to alter the processing of the streaming data within the distributed computing environment. According to the altered processing, the streaming data, which includes the one or more data sets, may be processed within the distributed computing environment.

### BACKGROUND

Present invention embodiments are related to systems, methods and computer program products for controlling processing of streaming data within a distributed computing environment. In particular, the present invention embodiments are related to detecting one or more conditions during processing of streaming data, inserting one or more data sets into the streaming data in response to detecting the one or more conditions, and processing the streaming data including the inserted one or more data sets.

Stream computing concerns the processing of streaming data in a distributed environment. In stream computing, data is essentially a mechanism for triggering execution of code, or software. Depending on the software being executed, data can trigger operators, processing elements, or Dstreams (discretized streams) to execute. As data moves from place to place, it is manipulated, transformed, or joined with other data before moving on to a next section of the code.

Stream computing is often used to find patterns in data, or derive information from raw data. Stream computing uses concepts such as windowing, which is a mechanism for acting on a group of data. Common operators in most streaming products that use windowing include, but are not limited to, aggregation, joins and sort operations. End users of stream applications may watch data flow and may view output.

### SUMMARY

In a first aspect of the invention, a method of controlling processing of streaming data within a distributed computing environment is provided. One or more conditions are detected during the processing of the streaming data within the distributed computing environment. One or more data sets are inserted into the streaming data in response to detecting the one or more conditions to alter the processing of the streaming data within the distributed computing environment. The streaming data, including the inserted one or more data sets is processed in the distributed computing environment according to the altered processing.

In a second aspect of the invention, a computing system is provided. The computing system includes at least one processing unit and at least one memory component having instructions recorded therein such that, when the at least one processing unit executes the instructions, the at least one processing unit performs: detecting one or more conditions during the processing of the streaming data within a distributed computing environment; inserting one or more data sets into the streaming data in response to detecting the one or more conditions to alter the processing of the streaming data within the distributed computing environment; and processing the streaming data including the inserted one or more data sets in the distributed computing environment according to the altered processing.

In a third aspect of the invention, a computer program product is provided. The computer program product includes, among other things, at least one computer readable storage medium having computer readable program code embodied therewith for execution on at least one processing unit. The computer readable program code is configured to be executed by the at least one processing unit to perform: detecting one or more conditions during processing of streaming data; inserting one or more data sets into the streaming data in response to detecting the one or more conditions to alter the processing of the streaming data; and processing the streaming data including the inserted one or more data sets in the distributed computing environment according to the altered processing.

### BRIEF DESCRIPTION OF THE DRAWINGS

Generally, like reference numerals in the various figures are utilized to designate like components.

FIG. 1 illustrates an example environment in which embodiments may be implemented.

FIG. 2 is a functional block diagram of a computing device that may be used to implement embodiments of the invention.

FIG. 3 is a graph that represents an example streams application.

FIG. 4 is a flowchart of an example process of injecting data in stream computing in an embodiment that uses a debugger.

FIG. 5 is a flowchart of another example process of injecting data in stream computing in an embodiment that uses a debugger.

FIG. 6 shows a flowchart of an example process of injecting data in stream computing in an embodiment for various scenarios.

### DETAILED DESCRIPTION

In a number of situations, a user may wish to inject data into a stream using stream runtime conditions such as for example, windowing, to cause an application to behave differently or, in some cases, to act at all. In some situations, in order to find patterns, applications may be executed, then re-executed to perform a second pass using modified data from an incoming data set being processed (e.g., adding new tuples, subtracting tuples, etc.). In other situations, no solutions may exist.

Present invention embodiments provide for real-time injection of stream data into a running application graph. In addition, the present invention embodiments provide a user with an ability to control how the data is injected into the running application graph. The data includes tuples, which are attributes and their corresponding values. Tuples may be injected into a data stream at various conditions including, but not limited to, conditions involving windowing, a join operator, or a barrier operator to trigger further execution.

Windowing is a grouping of tuples on which processing is to be performed. An eviction policy is defined for a window. The eviction policy may be for a tumbling window or a sliding window. An eviction policy for a tumbling window may include collecting tuples until a predefined number of tuples are collected, at which point the window is considered to be full. According to the eviction policy, the collected tuples are processed, the tuples are evicted from the window and a next window full of tuples may be collected, processed and evicted. An eviction policy for a sliding window collects a predefined number of tuples, at which point the window is considered to be full. According to this eviction policy, all tuples in the window are processed and an oldest tuple in the window is evicted. A newest arriving tuple is then included in the window, which at this point becomes full and includes all but the oldest tuple from the previous window and the newest arriving tuple. The window full of tuples is then processed, an oldest tuple in the window is evicted, and the process repeats. A third type of eviction policy causes received tuples to be collected in a window and processed and evicted every predefined time period.

A join operator joins tuples from two data streams. Tuples from each of the two data streams are present before a join operator can execute and produce an output tuple.

A barrier operator is used to synchronize tuples from two or more streams. Corresponding tuples from each input port are used by the barrier operator to create an output tuple. The barrier operator creates and sends the output tuple only when tuples have been received via all the input ports.

In some embodiments, a user may input one or more commands to monitor for an occurrence of a condition in which a window is only partially full for a predetermined period of time. Upon detecting the occurrence of the condition, one or more data sets, including tuples, may be injected such that a remaining data capacity of the window is utilized, thereby causing the window to become full, and the tuples of the full window to be processed. Similarly, the user may input one or more commands to monitor for an occurrence of a second condition in which a join operator has received one or more input tuples from one input stream and has been waiting for one or more input tuples from a second input stream for a predetermined period of time. Upon detecting the occurrence of the second condition, one or more tuples may be injected into the second input stream to cause the join operator to execute and produce one or more output tuples. Further, the user may input one or more commands to monitor for an occurrence of a third condition in which a barrier operator has received one or more input tuples from fewer than all input data streams and is waiting for one or more other input tuples on one or more other input data streams. Upon detecting the occurrence of the third condition, one or more tuples may be injected into the one or more other input data streams to cause the barrier operator to execute and produce one or more output tuples. Other conditions may also be monitored such that when the other conditions are detected, one or more tuples may be injected at a desired point a data stream.

In other embodiments, a breakpoint may be set using a debugger. The breakpoint may fire when an instruction at a particular location is about to be executed or when one or more specified conditions, as previously described, are detected. When the breakpoint fires during execution, processing regarding an operator associated with the breakpoint may be suspended and a user may enter one or more commands to inject one or more tuples at a desired point of the stream processing. Some embodiments may inject data sets including one or more tuples at the desired point when one or more specified conditions, as previously described, are detected without suspending any processing. Further, in some embodiments, when one or more specified conditions are detected, tuples output from an operator may be routed to a different operator than an operator to which the output tuples were previously routed.

The user may input one or more commands for injecting one or more particular tuples in a data stream. Further, the user may enter one or more commands for injecting one or more tuples such that the one or more tuples having normal values, abnormal values, or a combination of normal values and abnormal values are generated and injected at a desired point in a stream. Various embodiments may generate the normal values and the abnormal values using statistical techniques including, but not limited to, a standard deviation of values based on historical data.

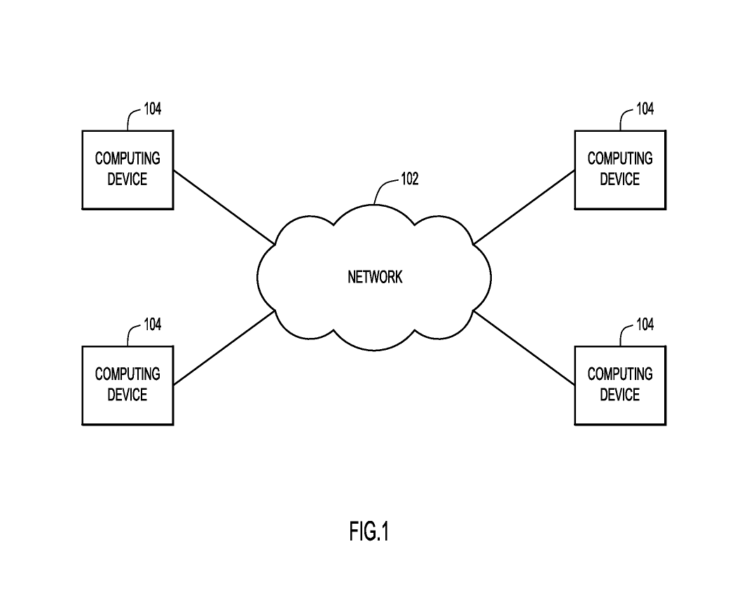

FIG. 1 shows an example environment in which various embodiments may be implemented. The example environment may include a network 102 and a number of computing devices 104 connected to network 102. Network 102 may include a local area network (LAN), a wide area network (WAN), a public switched data network (PSDN), the Internet, an intranet, other types of networks, or any combination of the above. Each of computing devices 104 may communicate with other computer devices 104 or with other devices connected to network 102.

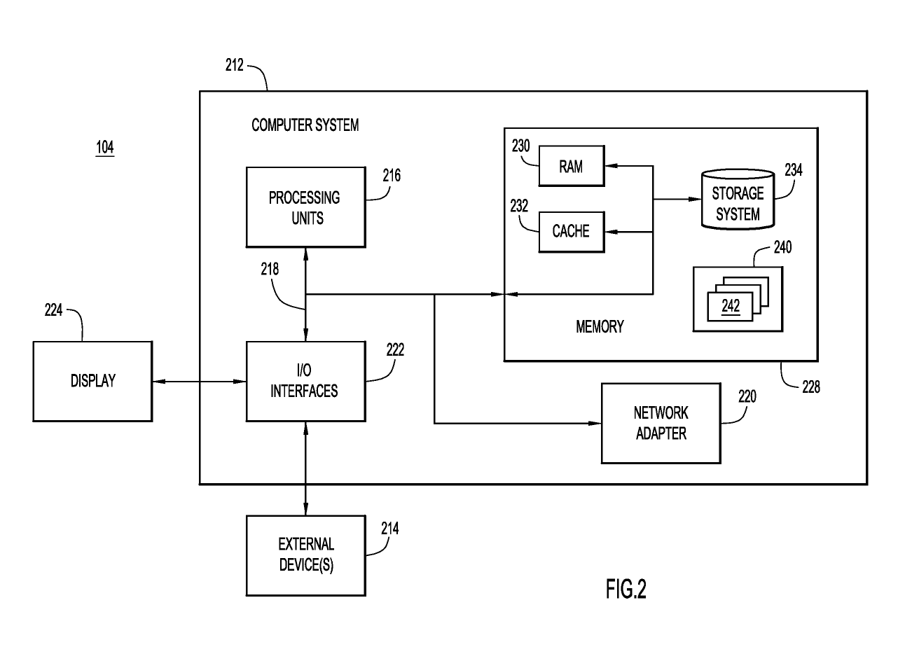

An example computing device 104 in which embodiments of the invention may be implemented is shown in FIG. 2. In some embodiments, multiple computing devices 104 connected with each other via network 102 may implement the embodiment. As shown in FIG. 2, computer system 212 is shown in a form of a general-purpose computing device. Components of computer system 212 may include, but are not limited to, one or more processors or processing units 216, a system memory 228, and a bus 218 that couples various system components including system memory 228 to one or more processors 216.

Bus 218 represents one or more of any of several types of bus structures, including a memory bus or memory controller, a peripheral bus, an accelerated graphics port, and a processor or local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnects (PCI) bus.

Computer system 212 typically includes a variety of computer system readable media. Such media may be any available media that is accessible by computer system 212, and includes both volatile and non-volatile media, removable and non-removable media.

System memory 228 can include computer system readable media in the form of volatile memory, such as random access memory (RAM) 230 and/or cache memory 232. Computer system 212 may further include other removable/non-removable, volatile/non-volatile computer system storage media. By way of example only, storage system 234 can be provided for reading from and writing to a non-removable, non-volatile magnetic media (not shown and typically called a “hard drive”). Although not shown, a magnetic disk drive for reading from and writing to a removable, non-volatile magnetic disk (e.g., a “floppy disk”), and an optical disk drive for reading from or writing to a removable, non-volatile optical disk such as a CD-ROM, DVD-ROM or other optical media can be provided. In such instances, each can be connected to bus 218 by one or more data media interfaces. As will be further depicted and described below, memory 228 may include at least one program product having a set (e.g., at least one) of program modules that are configured to carry out the functions of embodiments of the invention.

Program/utility 240, having a set (at least one) of program modules 242, may be stored in memory 228 by way of example, and not limitation, as well as an operating system, one or more application programs, other program modules, and program data. Each of the operating system, the one or more application programs, the other program modules, and the program data or some combination thereof, may include an implementation of a networking environment. Program modules 242 generally carry out the functions and/or methodologies of embodiments of the invention as described herein.

Computer system 212 may also communicate with one or more external devices 214 such as a keyboard, a pointing device, a display 224, etc.; one or more devices that enable a user to interact with computer system 212; and/or any devices (e.g., network card, modem, etc.) that enable computer system 212 to communicate with one or more other computing devices. Such communication can occur via Input/Output (I/O) interfaces 222. Still yet, computer system 212 can communicate with one or more networks such as a local area network (LAN), a general wide area network (WAN), and/or a public network (e.g., the Internet) via network adapter 220. As depicted, network adapter 220 communicates with the other components of computer system 212 via bus 218. It should be understood that, although not shown, other hardware and/or software components could be used in conjunction with computer system 212. Examples, include, but are not limited to: microcode, device drivers, redundant processing units, external disk drive arrays, RAID systems, tape drives, and data archival storage systems, etc.

A number of platforms exist for processing stream data. One example is IBM Streams (available from International Business Machines Corp. of Armonk, N.Y.), which is capable of processing vast amounts of data in real time. IBM Streams provides a programming model and an integrated development environment (IDE) in which data sources and software analytic modules, called operators, may be defined. The operators may be fused into processing execution units. Main platform components include a runtime environment, a programming model, monitoring tools and administrative interfaces.

The runtime environment includes platform services and a scheduler for deploying and monitoring stream applications across either a single host or a set of integrated hosts.

IBM Streams provides a programming model in which Streams applications may be written using Streams Processing Language (SPL), which is a declarative language. The runtime environment is responsible for determining how to service a request. An application executed on a platform for processing streaming data (a streaming application) may be represented as a graph that includes operators and streams that connect the operators.

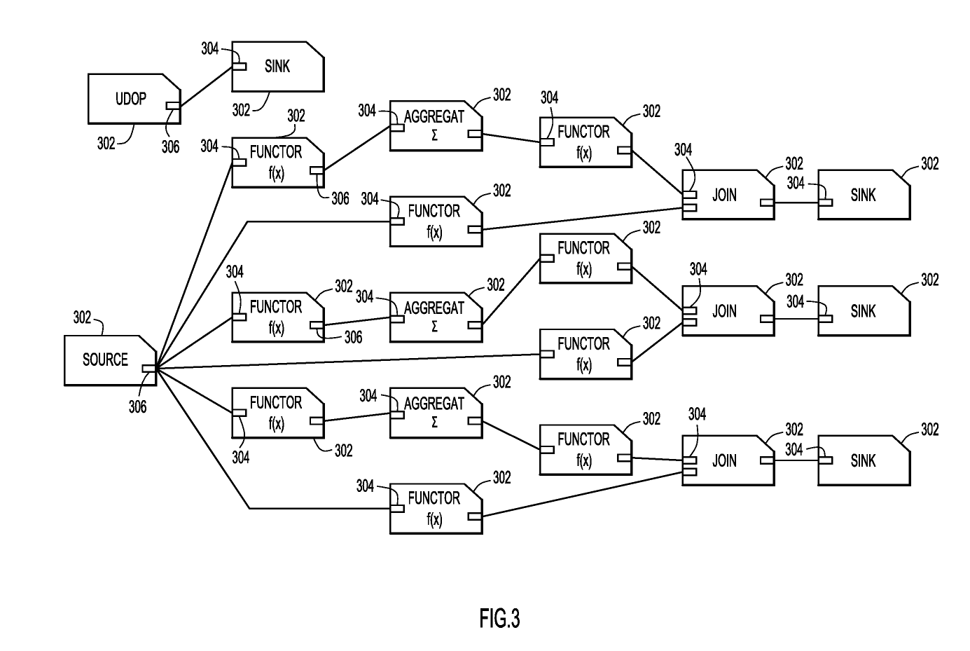

FIG. 3 shows a graph representing an example streaming application. Operators 302 may have either one or more input ports 304 or an output port 306, or may have one or more input ports 304 and an output port 306. Stream data include tuples, which are processed by operators 302. Operators may include, but are not limited to, a user-defined operator (UDOP), a sink operator (SINK), a function operator (FUNCTOR), a source operator (SOURCE), an aggregate operator (AGGREGAT), a barrier operator (not shown) and a join operator (JOIN).

The platform for processing stream (a stream platform) data may include a debugger. The debugger may allow a user to set breakpoints, trace points, and inject points. Breakpoints are used for suspending execution. Trace points are used for tracing data that is either flowing into or out of an operator. Inject points are used for inserting new tuples into an application's data flow at a specified port.

In various embodiments, breakpoints may be set to suspend execution based on detecting a number of different conditions, which may include, but are not limited to, a partially filled window existing for at least a predetermined time period, a join operator having received data on a first input port and waiting for data on a second input port for at least a predetermined time period, and a barrier operator having received data on at least one input port and is waiting for data on at least one other port for at least a predetermined time period. Breakpoints may also be set to suspend processing before a particular instruction at a specified memory location is to be executed.

Upon firing of a breakpoint and suspension of execution, a user may enter one or more commands to inject one or more tuples at an inject point and may enter a command to resume execution. The one or more commands to inject one or more tuples may include a definition of the one or more tuples. Alternatively, the one or more tuples may be defined at some point prior to the firing of the breakpoint. In some embodiments, the user may enter one or more commands to cause the debugger to generate the one or more tuples based on historical data. For example, the command for generating the one or more tuples may include a number of tuples to generate and a number or percentage of tuples having normal data values and/or a number or percentage of tuples having abnormal data values. The normal and abnormal data values may be generated based on historical data and a standard deviation of the historical data or via other methods. Further, the command for generating the one or more tuples may indicate that the data values are to be randomly generated or are to be generated according to a specified distribution, including, but not limited to a normal distribution. The one or more commands may further indicate that the one or more tuples are to be regenerated for injection, but are to be arranged in a different order based on randomization techniques.

Using the debugger, a user also may specify one or more conditions to detect, without suspending execution, along with data to inject at a defined inject point. The conditions may include, but not be limited to, a partially filled window that remains partially filled for a predetermined period of time, a join operator that has received a first input on a first input port and is waiting for a second input on a second input port for a predefined period of time, and a barrier operator that has received input on some input ports, but is waiting for input on one or more other input ports for a predefined period of time. The user may also enter commands to inject tuples automatically when the one or more conditions are detected.

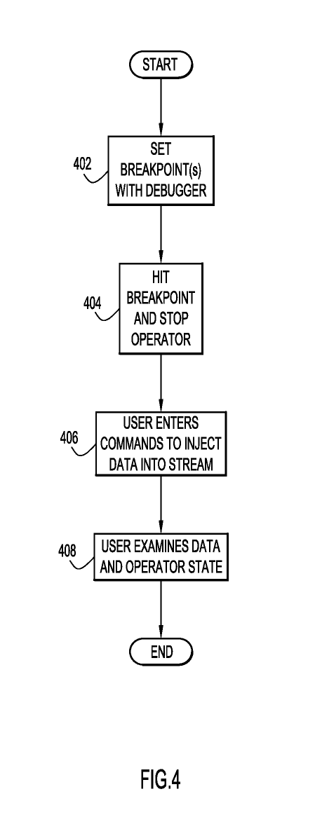

FIG. 4 is a flowchart that illustrates a process to inject data that may be performed in various embodiments that use a debugger with a stream platform. The process may begin with a user setting one or more breakpoints with a debugger. The one or more breakpoints may be set to suspend execution on a particular instruction or may be set to detect one or more conditions, as previously described (act 402). When the breakpoint fires, due to a computing device about to execute the particular instruction or due to the computing device detecting the one or more conditions, processing by a corresponding operator is suspended (act 404). Next, the user may enter commands, as previously described, to inject data such as one or more tuples into a stream at an injection point (406). The user may then examine an operator state of the corresponding operator as well as data and may enter a command to cause the corresponding operator to resume processing (act 408). In some embodiments, the user may enter one or more commands to reroute output tuples from an operator to a different operator than was done previously.

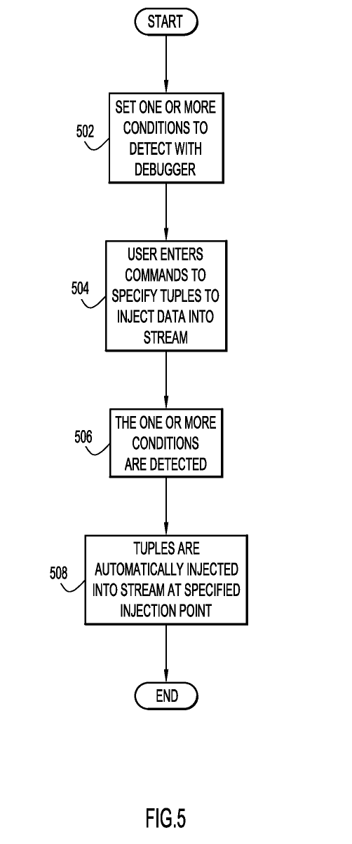

FIG. 5 is a flowchart that illustrates another process to inject data that may be performed in embodiments that use a debugger. The process may begin with a user using a debugger to set one or more conditions to detect (act 502). The one or more conditions to detect may be as previously described. Next, the user may enter commands to specify tuples to be injected into a stream at an injection point when the one or more conditions are detected by the debugger (act 504). In this embodiment, while an application is executing, the debugger detects the one or more conditions (act 506), does not suspend execution, and automatically injects tuples, as specified, into a stream at a specified injection point (act 508). The stream platform may provide the user with an ability to view a data flow of a stream as well as values of tuples during execution of the application.

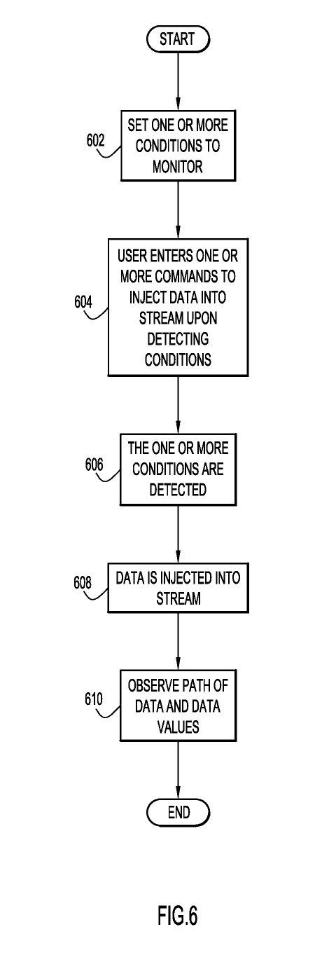

As previously mentioned, various embodiments may be implemented to inject data for various scenarios (e.g., without a debugger). FIG. 6 illustrates a process to inject data which may be performed in such embodiments. The process may begin with a user entering one or more commands to set one or more conditions to monitor, as previously described (act 602). Information regarding the one or more conditions may be provided to a runtime environment of a stream platform. One or more commands, as previously described, may be entered by a user to inject one or more tuples into an injection point of a stream upon detecting the one or more conditions (act 604). Information regarding the injection point and the one or more tuples to inject may be provided to the runtime environment via any one of a variety of input methods. When the runtime environment detects the one or more conditions (act 606), one or more tuples may be injected into the stream at the previously defined injection point by the runtime environment (act 608). During execution of an application, the user may observe a path of data and corresponding values via the stream platform (act 610).

The environment of the present invention embodiments may include any number of computers or other processing systems (e.g., client or end-user systems, server systems, etc.) and databases or other repositories arranged in any desired fashion, where the present invention embodiments may be applied to any desired type of computing environment (e.g., cloud computing, client-server, network computing, mainframe, stand-alone systems, etc.). The computer or other processing systems employed by the present invention embodiments may be implemented by any number of any personal or other type of computer or processing system (e.g., desktop, laptop, PDA, mobile devices, etc.), and may include any commercially available operating system and any combination of commercially available and custom software (e.g., browser software, communications software, server software, etc.). These systems may include any types of monitors and input devices (e.g., keyboard, mouse, voice recognition, etc.) to enter and/or view information.

It is to be understood that the software of the present invention embodiments may be implemented in any desired computer language and could be developed by one of ordinary skill in the computer arts based on the functional descriptions contained in the specification and flowcharts illustrated in the drawings. Further, any references herein of software performing various functions generally refer to computer systems or processors performing those functions under software control. The computer systems of the present invention embodiments may alternatively be implemented by any type of hardware and/or other processing circuitry.

The various functions of the computer or other processing systems may be distributed in any manner among any number of software and/or hardware modules or units, processing or computer systems and/or circuitry, where the computer or processing systems may be disposed locally or remotely of each other and may communicate via any suitable communications medium (e.g., LAN, WAN, Intranet, Internet, hardwired, modem connection, wireless, etc.). For example, the functions of the present invention embodiments may be distributed in any manner among the various systems, and/or any other intermediary processing devices. The software and/or algorithms described above and illustrated in the flowcharts may be modified in any manner that accomplishes the functions described herein. In addition, the functions in the flowcharts or description may be performed in any order that accomplishes a desired operation.

The software of the present invention embodiments may be available on a non-transitory computer useable medium (e.g., magnetic or optical mediums, magneto-optic mediums, floppy diskettes, CD-ROM, DVD, memory devices, etc.) of a stationary or portable program product apparatus or device for use with stand-alone systems or systems connected by a network or other communications medium.

The communication network may be implemented by any number of any type of communications network (e.g., LAN, WAN, Internet, Intranet, VPN, etc.). The computer or other processing systems of the present invention embodiments may include any conventional or other communications devices to communicate over the network via any conventional or other protocols. The computer or other processing systems may utilize any type of connection (e.g., wired, wireless, etc.) for access to the network. Local communication media may be implemented by any suitable communication media (e.g., local area network (LAN), hardwire, wireless link, Intranet, etc.).

The system may employ any number of any conventional or other databases, data stores or storage structures (e.g., files, databases, data structures, data or other repositories, etc.) to store information. The database system may be implemented by any number of any conventional or other databases, data stores or storage structures (e.g., files, databases, data structures, data or other repositories, etc.) to store information. The database system may be included within or coupled to a server and/or client systems. The database systems and/or storage structures may be remote from or local to the computer or other processing systems, and may store any desired data.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises”, “comprising”, “includes”, “including”, “has”, “have”, “having”, “with” and the like, when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiments were chosen and described in order to best explain the principles of the invention and the practical application, and to enable others of ordinary skill in the art to understand the invention for various embodiments with various modifications as are suited to the particular use contemplated.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

The present invention may be a system, a method, and/or a computer program product at any possible technical detail level of integration. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

We claim:

1. A method of controlling processing of streaming data within a distributed computing environment comprising:
detecting one or more conditions during the processing of the streaming data within the distributed computing environment;
inserting one or more data sets into the streaming data in response to detecting the one or more conditions to alter the processing of the streaming data within the distributed computing environment; and
processing the streaming data including the inserted one or more data sets in the distributed computing environment according to the altered processing.

2. The method of claim 1, wherein the one or more data sets include tuples.

3. The method of claim 1, wherein the inserting one or more data sets into the streaming data comprises:
inserting the one or more data sets into the streaming data in order to enable one or more specified actions.

4. The method of claim 3, wherein the one or more specified actions include one or more selected from a group of:
utilizing remaining data capacity in a window;
producing results from join operators; and
enabling further execution of a barrier operation.

5. The method of claim 1, wherein the one or more data sets include one or more selected from a group of normal values and abnormal values, and wherein the normal and abnormal values are determined based on historical data.

6. The method of claim 5, further comprising:
receiving an indication of quantities of the normal and abnormal values for the one or more data sets.

7. The method of claim 1, wherein the inserting one or more data sets into the streaming data comprises:
suspending at least some of the processing of the streaming data in response to detecting the one or more conditions; and
inserting the one or more data sets into the streaming data during suspension of the at least some of the processing.

8. The method of claim 1, wherein the inserting one or more data sets into the streaming data comprises:
inserting the one or more data sets into the streaming data during processing of the streaming data in response to detecting the one or more conditions.

9. A computing system comprising:
at least one processing unit; and
at least one memory having instructions recorded therein such that, when the at least one processing unit executes the instructions, the at least one processing unit performs:
detecting one or more conditions during the processing of the streaming data within a distributed computing environment;
inserting one or more data sets into the streaming data in response to detecting the one or more conditions to alter the processing of the streaming data within the distributed computing environment; and
processing the streaming data including the inserted one or more data sets in the distributed computing environment according to the altered processing.

10. The computing system of claim 9, wherein the one or more data sets include tuples.

11. The computing system of claim 10, wherein the inserting one or more data sets into the streaming data comprises:
adjusting an order of the tuples based on one or more selected from a group of randomization techniques and historical data.

12. The computing system of claim 9, wherein:
the one or more data sets include one or more selected from a group of normal values and abnormal values, and wherein the normal and abnormal values are determined based on historical data, and
the normal and abnormal values are based on standard deviations from values of the historical data.

13. The computing system of claim 9, wherein:
an eviction policy is employed to select data within windows of data, and
the at least one processing device further performs:
adjusting the eviction policy for the windows of data based on the processing of the streaming data including the inserted one or more data sets.

14. A computer program product comprising:
at least one computer readable storage medium having computer readable program code embodied therewith for execution on at least one processing unit, the computer readable program code being configured to be executed by the at least one processing unit to perform:
detecting one or more conditions during processing of streaming data;
inserting one or more data sets into the streaming data in response to detecting the one or more conditions to alter the processing of the streaming data; and
processing the streaming data including the inserted one or more data sets in the distributed computing environment according to the altered processing.

15. The computer program product of claim 14, wherein the one or more data sets include tuples.

16. The computer program product of claim 14, wherein the inserting one or more data sets into the streaming data comprises:
inserting the one or more data sets into the streaming data in order to enable one or more specified actions including one or more selected from a group of:
utilizing remaining data capacity in a window;
producing results from join operators; and
enabling further execution of a barrier operation.

17. The computer program product of claim 14, wherein the inserting one or more data sets into the streaming data comprises:
suspending at least some of the processing of the streaming data in response to detecting the one or more conditions, and
inserting the one or more data sets into the streaming data during suspension of the at least some of the processing.

18. The computer program product of claim 14, wherein the inserting one or more data sets into the streaming data comprises:
inserting the one or more data sets into the streaming data during processing of the streaming data in response to detecting the one or more conditions.

19. The computer program product of claim 14, wherein:
the one or more data sets include one or more selected from a group of normal values and abnormal values, and wherein the normal and abnormal values are determined based on historical data, and
the normal and abnormal values are based on standard deviations from values of the historical data.

20. The computer program product of claim 14, wherein:
the one or more data sets include tuples, and
the inserting one or more data sets into the streaming data comprises:
adjusting an order of the tuples based on one or more selected from a group of randomization techniques and historical data.
